(19) United States
(12) Patent Application Publication
(10) Pub. No.: US 2026/0138054 A1
(43) Pub. Date: May 21, 2026

(54) CHROMATOGRAPHY COLUMN WITH MULTIPLE COLUMN ACCESS PORTS ALONG COLUMN LENGTH

(71) Applicant: Thermo Finnigan LLC, San Jose, CA (US)

(72) Inventor: Gary Schultz, Ithaca, NY (US)

(73) Assignee: Thermo Finnigan LLC, San Jose, CA (US)

(21) Appl. No.: 18/951,461

(22) Filed: Nov. 18, 2024

(51) Int. Cl. B01D 15/22; B01D 15/20

(52) U.S. Cl. CPC B01D 15/22; B01D 15/203

(57) ABSTRACT

An apparatus includes a chromatography column, the column including a separation channel having a length extending between a column input port and a column output port and at least one intermediate input port coupled to an intermediate position along the length of the separation channel, wherein the at least one intermediate input port is situated to receive and direct a fluid into the separation channel to travel toward the column input port and toward the column output port and to clean the separation channel. A method includes directing a fluid into the separation channel through the at least one intermediate input port to travel toward the column input port and toward the column output port to clean the separation channel.

### FIELD

The field is chromatography.

### BACKGROUND

Chromatography is a family of chemical processes in which a mixture becomes separated into constituents by dissolving a sample in a fluid solvent and transporting this mobile phase through a stationary phase material. The interaction by the constituents and the stationary phases causes differential migration of the constituents through the chromatography device resulting in temporal constituent separation elution from the device. The time required to complete a chromatography process can be a particularly important factor, with longer durations undesirably extending the time required to complete an experiment or to preparate separated material for other processes and experiments. Thus, a need remains for improvements to chromatography systems and processes.

### SUMMARY

According to an aspect of the disclosed technology, an apparatus includes a chromatography column that includes a separation channel having a length extending between a column input port and a column output port. The column includes at least one intermediate input port coupled to an intermediate position along the length of the separation channel. The intermediate input port can be situated to receive and direct a fluid into the separation channel, which can be used advantageously for various purposes, such as to clean and/or equilibrate the separation channel. This can enhance the speed of such operations. For example, directing the fluid into the intermediate input port can cause the fluid to travel toward the column input port and toward the column output port and to clean the separation channel. The intermediate input port or ports can be applied in both substrate-style and capillary-style chromatography columns.

According to another aspect of the disclosed technology, a method can be applied to a chromatography column that includes a separation channel having a length extending between a column input port and a column output port and at least one intermediate input port coupled to an intermediate position along the length of the separation channel. The method can include directing a fluid into the separation channel through the at least one intermediate input port, which can be used advantageously for various purposes, such as to clean and/or equilibrate the separation channel. This can enhance the speed of an overall chromatography process workflow by enhancing the speed of such operations. Directing the fluid into the intermediate input port can cause the fluid to travel toward the column input port and toward the column output port to clean the separation channel. In some examples, intermediate output ports can be closely arranged proximate the intermediate input ports, e.g., opposite the intermediate input ports for fluid to be directed across the separation the channel, e.g., perpendicular to the flow direction of the separation channel. The intermediate input port or ports (and intermediate output ports) can be applied in both substrate-style and capillary-style chromatography columns.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic of a liquid chromatography column, including related components.

FIGS. 2A-2B are perspective and side cross-sectional views of a portion of another liquid chromatography column.

FIG. 3 is a side schematic of another chromatography column.

FIG. 4 are perspective views of another portion of a chromatography column.

FIG. 5 is a flowchart of example liquid chromatography methods.

### DETAILED DESCRIPTION

Many chromatography separation columns consist of a cylindrical body containing stationary phase particles with micron dimensions and that have a stationary phase coating. The stationary phase is often retained in the column body using frits and fittings on each end of the column. Solvents are introduced into one column end and exit the other end. Chromatography columns, in tubular or silicon-based formats, typically have one input port for connection to an input portion of the chromatography system and one output port for connecting to a chromatography system detector or to an ion source of a mass spectrometer for analysis. Longer column formats can have several performance benefits including increased resolution between separated bands of constituents. However, longer columns also operate at higher pressures and require longer wash, equilibration, and sample injection times, as compared with shorter columns. Many disclosed examples herein enjoy the performance benefits of longer columns while avoiding the associated drawbacks by reducing the time required in preparing for sample injection, such as that associated with washing and equilibrating the stationary phase. Washing involves cleaning the existing column contents, e.g., by flushing to remove the contents of previous experiments. Equilibration involves establishing consistent mobile phase and stationary phase contents in the column prior to a sample run. Columns can contain multiple access points along its length, which can also reduce sample injection times by enabling sample injections at higher flow rates. These access points (ports) can be used to introduce solvents during the wash, equilibration, and sample injection steps of disclosed liquid chromatography method examples, leading to enhanced methods with reduced step durations. In some examples, chromatography column devices include more than one access port for solvent flow delivery to the stationary phase in a support structure which has one or more access ports orthogonal to a separation axis of the column. This can reduce the duration of column washing and equilibration steps in proportion to the number of orthogonal access ports, in turn leading to reduced sample carryover and higher sample throughput. During sample injection through multiple ports, a sample volume will flow through a shorter length of the overall column length. Benefits can include reduced sample injection times compared with currently available separation devices by enabling higher sample injection flow rates.

Thus, various disclosed examples can reduce column wash and equilibration time using multiple access ports along the length of the separation device. Further, examples can reduce column sample carryover by enabling higher flow rates at reduced pressures. Sample injection time and pressure can be reduced through the introduction of the sample to the column over a shorter overall length of the stationary phase relative to the column length. Disclosed examples can more efficiently perform chromatography operations resulting in an increase in samples analyzed per day.

Liquid chromatography gradient separations typically consist of several steps to complete each sample analysis. Time is required to equilibrate the column stationary phase in preparation for sample injection, gradient separation, and column washing/cleaning to prepare the column for subsequent analyses. Each of these steps can be divided into time segments with the sum of each segment equal to the total analysis time between sample analyses. In preferred practice, the gradient time is a significant percentage of the total analysis time so as to maximize process efficiency. However, for longer columns, and fast separations, gradient time may be closer to one-half of total analysis time in currently available instruments. In disclosed examples, time for column washing, equilibration, and sample injection can be reduced based on various improved arrangements of access ports.

In some examples, a separation column contains at least one additional port located at a mid-point of the column separation axis. After completion of a gradient separation step, solvent is introduced through this port and flows equally towards each end of the column, thereby effectively halving the time required to wash and equilibrate the column.

In further examples, an orthogonal flow configuration can be provided in a cylindrical or other shaped column body that contains porous body sections with porous regions that are on opposite sides along the column length containing the stationary phase. During separation, these porous structures are blocked to flow, enabling axial separation of injected samples as with a traditional column. After completion of a gradient separation step, the porous structures can be opened to flow so that the column can be washed and equilibrated quickly across the column diameter rather than along the column length. This can effectively reduce the time required to wash and equilibrate the column by a factor equal to the column length divided by the column diameter.

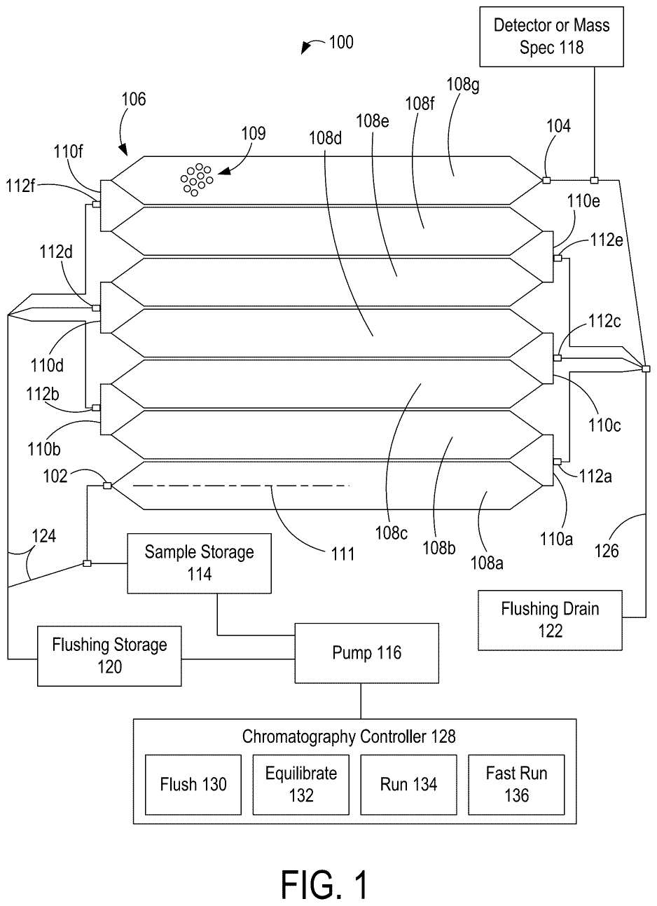

FIG. 1 shows an example liquid chromatography column 100. In some examples, the column 100 is a microfluidics-based column, e.g., with features formed in a semiconductor substrate that is capped by a top layer to form a leak-free microfluidic device. In some examples, the column 100 can have a glass-bonded top layer. The column includes an input port 102 (also referred to as a gradient input), an output port 104 (also referred to as a gradient output), and a serpentine arrangement 106 of separation channel segments 108a-108g (also referred to as channels or lanes) adjacently arranged and extending between the inlet 102 and outlet 104. The channel 108a can correspond to first or inlet channel and the channel 108g can correspond to a last or outlet channel. Most or all the channels 108a-108g can contain stationary phase of material 109, schematically depicted only in channel 108g for clarity of illustration. Connection paths 110a-110f, also referred to as connectors, are arranged to connect the separation channels 108a-108g to define a serpentine separation axis 111, only a portion of which being shown in separation channel 108a. The connection paths 110a-110f can be coupled to intermediate access ports 112a-112f. Ports 112a-112f can include controllable valves that direct flow (e.g., Viper and nanoViper fittings and valves made by Thermo Fisher Scientific or other flow control fittings suitable for chromatographic applications). One or more of the intermediate access ports 112a-112f can be coupled through connection paths 110a-110f to an intermediate position or positions of the column 100. For example, at least one of the intermediate positions can be situated between 30% and 70% of the length of the separation channel 108a-108g. In further examples, an intermediate position can correspond to between 40% and 60%, 45% and 55%, 48% and 52% of the length, etc.

In some examples, the column 100 can be a micro pillar array column (μPAC™ columns produced by Thermo Fisher Scientific, Inc.). Such columns can be silicon-based micromachined columns. Various lengths are possible, e.g., 5 cm, 10 cm, 30 cm, 60 cm, 100 cm, etc. Columns can be micromachined in a silicon wafer with numerous parallel separation lanes each with a predetermined length, such as corresponding to channels 108a-108g. For example, fifteen column segments each with a 4 cm length can correspond to a column with a 60 cm length.

During a chromatography process, a sample analyte mixed with a solvent can be injected from a sample storage 114 into the column 100 through the input port 102, e.g., with a pump 116 coupled to the sample storage 114 to push the solvent mixture, also referred to as a mobile phase, into the channel 108a. The high pressure from the pump pushes the mobile phase through the stationary phase of the channels 108a-108g. As the constituents of the mobile phase separate due to interaction with the stationary phase, separation occurs so that different constituents arrive at the outlet 104 and can be directed to a detector 118 (or other collector) or to an ion source of a mass spectrometer at different times. This timing difference can be used to sort different constituents for preparation or analysis. Before the separation process (or after in preparation for a subsequent separation), the pump 116 can be coupled to a flushing storage 120 to cause a flushing solvent to be pumped through the separation channels 108a-108g to a flushing drain 122 or waste collector, as discussed further hereinbelow.

A challenge that exists with the column 100 and other chromatography columns is that when fluidic pressure is applied to the gradient input, such as input port 102, the fluidic pressure is highest at the input port 102 and lowest at the output port 104, with an accompanying pressure drop across the length of the separation column. While the gradient is a necessary part of the analytical separation mechanism of chromatography analysis, the high pressure limits the speed at which the channels 108a-108g can be flushed with a washing solvent, flushed with an equilibration solvent, and loaded with the mobile phase sample as any fluids input into a conventional column must traverse the entire length of the column at a slow speed dictated by the pressure drop across the entire length of the column. Disclosed examples like column 100 can allow for fast loading, fast equilibrating, and/or fast cleaning through the inclusion and use of a plurality of intermediate access ports, such as ports 112a-112f.

With the intermediate ports like ports 112a-112f, numerous parallel lanes (such as adjacently arranged separation channels 108a-108g) can be washed simultaneously, thereby speeding up the process of washing the entire separation column. As can be seen from FIG. 1, the intermediate access ports 112a-112f coupled to the various intermediate serpentine structures defining the separation column 100 can be configured to be open and closed. The ports 112a-112f can be normally closed during operation of a chromatography process, with input and output ports 102, 104 being selectively opened to allow the sample analyte in the mobile phase to propagate through the column channels 108a-108g towards the detector 118 (or other output device). The ports 112b, 112d, 112f can be coupled to an input flushing manifold 124 that can be coupled to the flushing storage 120 so that when the ports 112b, 112d, 112f are opened, the pump 116 can be operated to push cleaning solvent into the channels 108a-108g simultaneously, e.g., so as to travel from left to right as shown in FIG. 1. At the same time, ports 112a, 112c, 112e can be opened to allow cleaning solvent to travel through an output flushing manifold 126 to the flushing drain 122. In some examples, the input flushing manifold 120 can be coupled to the input port 102 so that flushing solvent can be flushed through the input port 102 and the output flushing manifold 126 can be coupled to the output port 104 to ensure the input and output channels 108a, 108g can be flushed.

In the 60 cm, 15 channel example discussed above, flushing through each lane simultaneously can result in a 15-fold speed increase in this part of the chromatography procedure. Also, due to a corresponding 15-fold lower pressure drop across each 4 cm channel as compared with the pressure drop across the 60 cm length, the flow rate can be increased 15-fold to match the pressure of a 60 cm column. This increased flow rate can further reduce the time required to perform the cleaning and equilibration portion of the chromatography procedure. In general, the larger the quantity of access ports, like ports 112a-112f, the faster the chromatography device can be washed and equilibrated and the next sample injected. For example, where a liquid chromatography process might have an overall method duration of 60 minutes, with 30 minutes of gradient separation and 30 minutes of washing, equilibrating and sample injection in a conventional column, column examples in accordance with the disclosed technology can reduce the duration of washing, equilibrating and sample injection to less than 1 minute. In a further example, a 25-channel column of 60 cm length (i.e., 2.4 cm length per channel) would enable even faster equilibration for the next injection than the 15-channel example due to the increased parallelization of cleaning and shorter length for each individual channel.

In some examples, the ports 102, 104 and intermediate ports 112a-112g can be selectively controlled. For example, to increase the speed of a chromatography process, the input port 102 can be opened and the intermediate port 112a (or another intermediate port) can be opened while other ports are in a closed position, allowing a sample analyte to flow more quickly into a beginning portion of the separation column (e.g., channel 108a). The intermediate port 112a can then be closed and the output port 104 opened to allow the chromatography process to proceed. Furthermore, to vary process speed, the length of the column 100 can be selected by bypassing one or more of the channels 108a-108g of the column 100. For example, port 112d can be closed and port 112c opened to cause the sample analyte to bypass channels 108d-108g. Thus, the column 100 can operate as a long separation device when additional separation resolution is required for the analysis or it can be configured to be a fast separation device by using a lower number of channels.

Thus, the presence of a plurality of intermediate access ports not only allow quick loading of the sample to jumpstart the chromatography process but also the abilities to wash all of the lanes quickly and to equilibrate all of those lanes quickly. In some examples, each of the channels 108a-108g can include an intermediate access port, though such an arrangement is not necessary in all examples. However, the addition of intermediate ports to intermediately direct flow into the channels of the column 100 and intermediately direct flow out of the channels 108a-108g allows for a reduction in pressure drop across the channels 108a-108g during the cleaning and/or equilibration procedure. This reduction is allowed because of the shorter distance traveled by the cleaning or equilibration solvent through column 100, e.g., as compared to flushing only between the input and output ports 102, 104. Further, because the pressure drop is reduced due to the shorter propagation distance, a higher pressure can be applied during the flushing and/or equilibration to decrease the duration required to flush the same amount of solvent without exceeding pressure constraints associated with the channels 108a-108g of the column 100.

This reduced duration for cleaning and equilibration can represent a substantial improvement to the chromatography process. For example, in many devices and processes a chromatography gradient separation can normally require 50% to 80% of the process time while washing, equilibrating, and loading the sample can occupy 20% to 50% of the process time. Thus, substantial increases in process efficiency can be obtained through the reduced cleaning and equilibration durations. For example, the time to clean and load a sample can depend on the number of lanes and the overall length of the column. Thus, the longer the column length and the more channels present, the more time that is required to wash and equilibrate the device. As the column length is reduced (e.g., with a lower number of lanes) then the process times are shorter, because solvent can be directed through at a higher flowrate without exceeding pressure limits associated with the microfluidic components. For example, in planar assemblies, an excessive pressure can cause layers to delaminate, e.g., causing a separation between a silicon substrate and a glass layer.

In many examples, the column 100 can be part of a larger chromatography system that can include a chromatography controller 128 that can include one or more processors and memories having stored or being configured to receive processor-executable instructions for executing various control and execution tasks for the column 100. For example, these can include various instructions routines, such as a flushing routine 130, equilibration routine 132, separation routine 134, and/or fast run routines 136. Controller 128 can be coupled to various components of the column 100, such as the pump 116, etc.

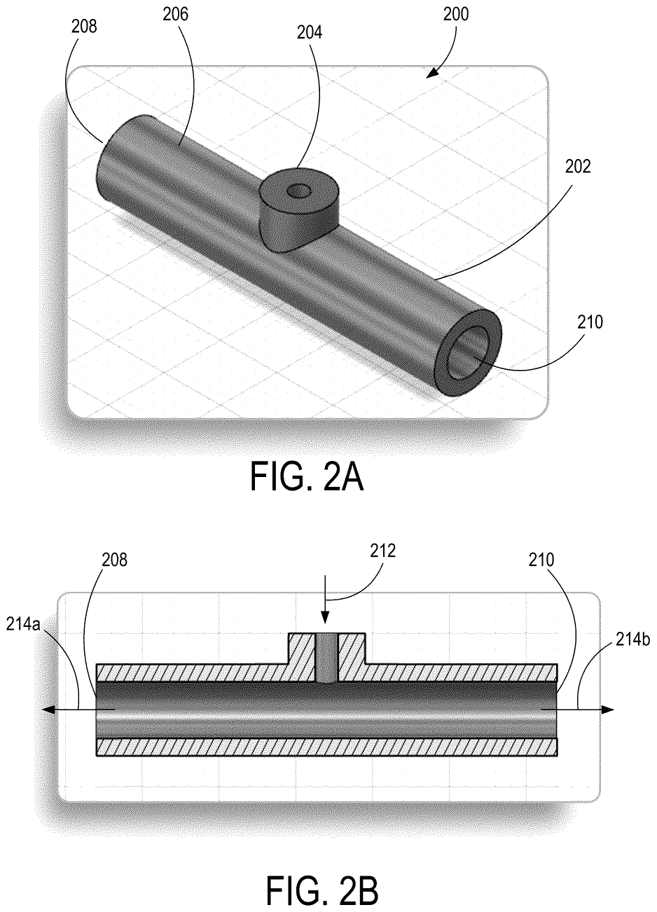

FIGS. 2A-2B shows another example column 200, specifically of a short length portion 202 of the column 200. In some examples, the short portion 202 is situated approximately at a midpoint of the length of the column 200. The column 200 can include many of the same or similar components as the column 100. The column 200 can have a tubular form defining an interior separation channel, rather than a silicon- or semiconductor-based microfabricated device composed of layers (e.g., as opposed to selected examples of column 100). Tubular examples can correspond to capillary-type columns. As shown, the cross-section of the column is circular though other tubular configurations like elliptical, square, rectangular, etc., are possible. The cross-section can be constant across the entire or substantially the entire length of the channel, e.g., excluding input, output, and/or port transitions. Example common cross-sectional diameters (or equivalent diameters) can include 10 mm, 5 mm, 4.6 mm, 2.1 mm, 1 mm, 0.5 mm, 0.3 mm, 0.15 mm, 100 μm, 75 μm, 50 μm, 10 μm, etc. Most chromatographic systems are in the tubular form and commonly 5, 15, or 25 cm in length. Again, length of time to wash and equilibrate the column can be long relative to separation time. This extensive duration increases the duty cycle and thereby prolongs the duration before a sample can be injected to perform the chromatography process. Because the speed of analysis can be important in many areas of chromatography, disclosed tubular examples can achieve a reduction in cleaning and equilibrating time consistent with some of the principles associated with the column 100.

For example, as shown in FIG. 2A, one or more intermediate side ports 204 can be present in a side 206 of the column 200. The side port 204 can be situated intermediately along the length of the column 200, e.g., with the portion 202 situated approximately at a center of the length of the column 200. Cleaning and equilibration can be performed, e.g., by directing solvent through the side port 204 allowing the solvent to flow to an input end 208 of the portion 202 and an output end of the portion 202. The side port 204 can be orthogonally arranged with respect to the separation path of the column. During a chromatography process, the side port 204 can remain closed. During cleaning, by directing the solvent through the side port 204, the washing and equilibrating duration for the column 200 can be reduced in range from one-half to one-quarter as compared with the time needed for the same step when directing solvent from an input end to an output end of the column 200. Additional side ports like the side port 204 can be present along the length of the column 200. Ports can be formed in various ways, e.g., by drilling holes in the side 206 of the column 200. FIG. 2B shows a cross-section of the portion 202 with input directional arrow 212 into side port 204 and output directional arrows 214a, 214b showing the direction of solvent flow through the portion 202 and out the input and outputs ends 208, 210 of the portion 202. With multiple side ports, input ports can be alternated with output ports to allow shorter length portions for flushing and equilibrating of the column 200. Even with a single side port, e.g., with side port 204 situated at approximately a mid-point of the column between the input and output, directing solvent through this orthogonal access port and out the input and output ends of the column can reduce the time required to equilibrate the stationary phase for the next sample injection by a factor of two to four (e.g., twice as fast for the same linear velocity of the column or four times faster by increasing the pressure to that applied between the input and output).

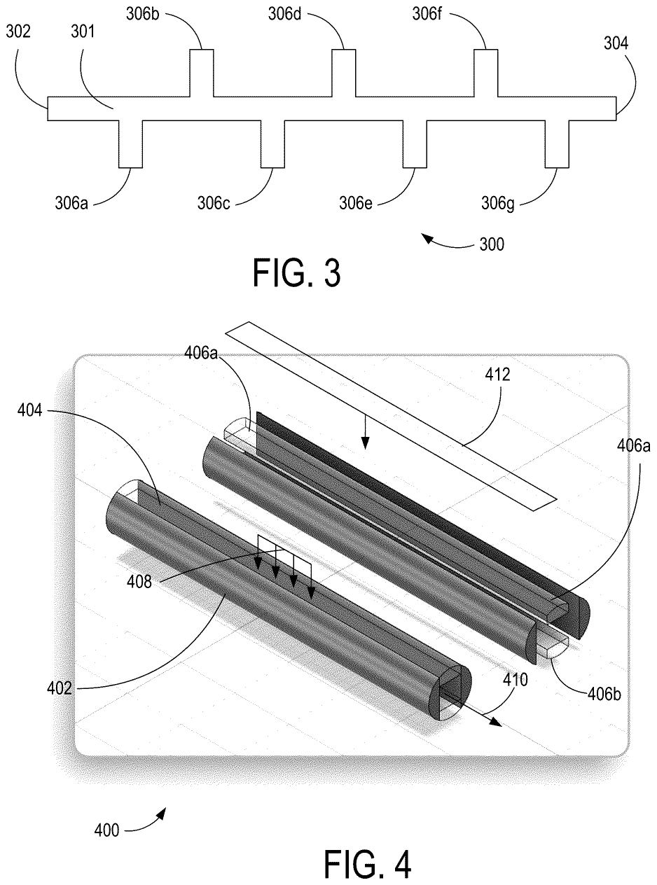

In many examples, the duration of column wash and equilibration steps can be reduced by the square of the number of column segments. For example, in the column 200 with only one of the intermediate side ports 204, having two segments corresponds to a four-fold increase. In the example in FIG. 3 discussed hereinbelow, eight segments can correspond to a sixty-four-fold increase. This increase can be a result of both a reduction in length and available increase in pressure.

FIG. 3 shows a cross-section of another example of a column 300 having a separation length 301 extending between an input port 302 and an output port 304. The column 300 can be tubular. The column 300 can include a plurality of side ports 306a-306g. Different ones of the side ports 306a-306g can be used to increase the speed of cleaning the separation length 301, e.g., by directing solvent into the separation length 301 through ports 306a, 306c, 306e, 306g and directing the solvent out of the separation length through ports 302, 304, 306b, 306d, 306f, though other configurations are possible. As shown, the side ports 306a-306g have an alternating appearance, e.g., with respective axes perpendicular to a separation channel axis and alternately extending up or down from the separation channel. In some examples, the side ports can be coupled to a common side (e.g., all coming out the top or bottom). In further examples, other arrangements can be provided, including non-alternating, random, 90-degree alternating, etc.

FIG. 4 is another example tubular column 400 that can be similar in various respects to the columns 100, 200, 300, with a short portion 402 of the column 400 being shown. In FIG. 4, two views are shown with the left-side view showing the column 400 and the right-side view showing a slightly exploded version of the column 400. In the column 400, the number of side ports can be increased to a substantially larger number of ports, e.g., in the form of a continuous side port region 404 that can extend for a portion of a length of a separation channel of the column 400 (e.g., the length of the short portion 402) or the entire length of the column 400. In some examples, the continuous side port region 404 can include opposing regions 406a, 406b. The opposing regions 406a, 406b can be arranged across from each other so as to form an orthogonal flow configuration, e.g., with flow along arrow 408, relative to a directional flow 410 of the chromatography separation through the length of the column 400. The orthogonal flow can mix and spread laterally in the channel (e.g., towards the input and output) as it propagates orthogonally from the region 406a to the region 406b to clean the stationary phase contents of the separation channel.

In some examples, the continuous side port region 404 can be porous. In some examples, the tubular column 400 can be made of a singular material, e.g., metal or ceramic, and the porousness of the continuous side port region 404 can be defined by an arrangement of small holes, e.g., formed with a laser or electron beam, that can be closely arranged. Holes can have various widths, e.g., is less than or equal to 0.5, 0.2, 0.1, 0.01, or 0.001 of a diameter of the separation channel and can be separated from each other by various distances, e.g., less than or equal to 0.5, 0.2, 0.1, 0.01, or 0.001 of a diameter of the separation channel, and/or less than equal to 0.2×, 0.5×, 1×, 2×, 5×, 10×, or 50× of a hole width. Holes can be arranged in a straight line or to cover an area. In some examples, the continuous side port region 404 can be arranged adjacent to a cover or block 412. The block 412 can be configured to removably cover the region 404, e.g., by being brought into contact with an outside of the continuous side port region 404 to block the orthogonal flow 408 of cleaning and equilibrating solvent into or out of the interior of the column 400. Another block (which is not shown for clarity of illustration) can be arranged on the opposite side to block flow on the opposing side. During a cleaning operation, the block 412 can be withdrawn to allow solvent to flow orthogonally through continuous side port region 404. In some examples, the block 412 can comprise a sleeve that can slide to cover the outside of the continuous side port region 404 to block flow. For example, the block can slide axially along the length of the tube and/or rotated about a circumference of the tube. By using the continuous side port region 404, the duration of cleaning, washing, and equilibrating can be substantially reduced by flushing across the inner diameter of the tube rather than along a length of the tube. In some examples, a continuous side port region can include an arrangement of holes only on one side, e.g., to operate only as an input or output. In such cases, flow would exit the portion 402 through the inlet and/or outlet of the portion.

In some examples, the arrangement of small holes can include 50 or more holes, which can correspond to access ports along the length of the column. Each of the porous access ports can be isolated from adjacent porous regions by non-porous regions. As discussed above, during a gradient separation, the porous regions can be blocked from flow so that separation can occur along the column. During a stationary phase washing and equilibration operation, the porous regions can be open to receive flow from a solvent delivery device (such as a pump coupled to a solvent reservoir) to enable washing of the stationary phase in the column approximately across the width of the column rather than over the column length. A corresponding minimum speed increase can be the column length (L) divided by the column diameter (d). The speed can be even higher because the flow rate can be further increased due to the low pressure across a column diameter compared to its length. In an example, using a 150 mm by 2.1 mm column, the column having an arrangement of holes for orthogonal flushing can be 75 times faster for stationary phase preparation for serial injections.

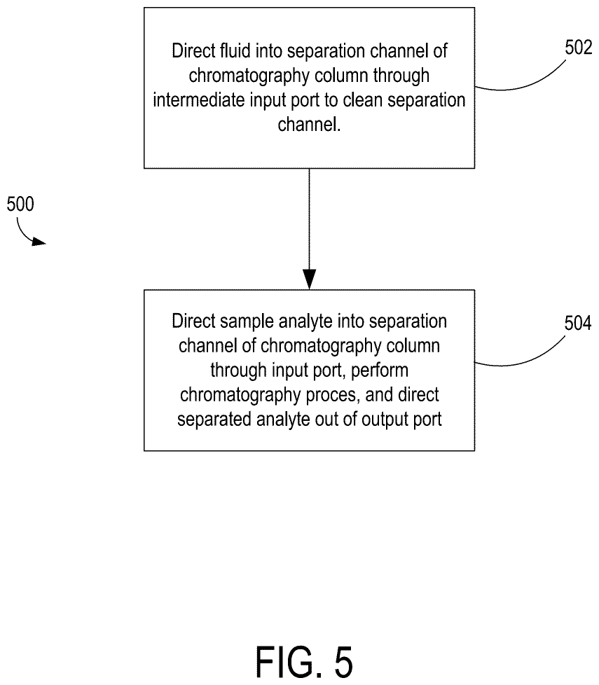

FIG. 5 is a method 500 in accordance with disclosed examples. At 502, a fluid (such as a solvent) is directed into a separation channel of a chromatography column through an intermediate input port to clean the separation channel. The fluid can be directed through one intermediate port or multiple intermediate ports, in accordance with various examples described herein. The fluid can travel to a column input, column output, other intermediate ports, and/or across to an opposing side. The intermediate port or ports can be used to increase the speed of cleaning the separation channel. In some examples, at 504, a sample analyte can be directed into the separation channel of the chromatography column through a column input. A separation can occur along the separation channel and analyte can be directed out a column output.

### General Considerations and Additional Examples

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

Unless otherwise stated, as used herein, the term “substantially” means the listed value and/or property and any value and/or property that is at least 75% of the listed value and/or property. Equivalently, the term “substantially” means the listed value and/or property and any value and/or property that differs from the listed value and/or property by at most 25%. For example, “substantially equal” refers to quantities that are fully equal, as well as to quantities that differ from one another by up to 25%.

The systems, apparatus, and methods described herein should not be construed as limiting in any way. Instead, the present disclosure is directed toward all novel and non-obvious features and aspects of the various disclosed examples, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, and the like may be characterized by qualifying terms such as “lowest,” “best,” “minimum,” “extreme,” etc. It is to be understood that such descriptions are intended to indicate that a selection among many used functional alternatives can be made, and such selections need not be better, smaller, or otherwise preferable to other selections.

The innovations can be described in the general context of computer-executable instructions, such as those included in program modules, being executed in a computing system on a target real or virtual processor. Generally, program modules or components include routines, programs, libraries, objects, classes, components, data structures, etc., that perform particular tasks or implement particular abstract data types. The functionality of the program modules may be combined or split between program modules as desired in various examples. Computer-executable instructions for program modules may be executed within a local or distributed computing system. In general, a computing system or computing device can be local or distributed, and can include any combination of special-purpose hardware and/or general-purpose hardware with software implementing the functionality described herein, examples of which include personal computers, hand-held devices, tablets, multiprocessor systems, microprocessor-based or programmable consumer electronics, network PCs, minicomputers, mainframe computers, virtual machines, containerized applications, etc.

In various examples described herein, a module (e.g., component or engine) can be “programmed” and/or “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

Described algorithms may be, for example, embodied as software or firmware instructions carried out by a digital computer. For instance, any of the disclosed methods can be performed by one or more a computers or other computing hardware that is part of a chromatography tool. The computers can be computer systems comprising one or more processors (processing devices) and tangible, non-transitory computer-readable media (e.g., one or more optical media discs, volatile memory devices (such as DRAM or SRAM), or nonvolatile memory or storage devices (such as hard drives, NVRAM, and solid-state drives (e.g., Flash drives)). The one or more processors can execute computer-executable instructions stored on one or more of the tangible, non-transitory computer-readable media, and thereby perform any of the disclosed techniques. For instance, software for performing any of the disclosed examples can be stored on the one or more volatile, non-transitory computer-readable media as computer-executable instructions, which when executed by the one or more processors, cause the one or more processors to perform any of the disclosed techniques or subsets of techniques.

Having described and illustrated the principles of the disclosed technology with reference to the illustrated examples, it will be recognized that the illustrated examples can be modified in arrangement and detail without departing from such principles. For instance, elements of examples performed in software (such as specific chromatography control actions) may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

Example 1. An apparatus comprising: a chromatography column including a separation channel having a length extending between a column input port and a column output port and at least one intermediate input port coupled to an intermediate position along the length of the separation channel, wherein the at least one intermediate input port is situated to receive and direct a fluid into the separation channel to travel toward the column input port and toward the column output port and to clean the separation channel.

Example 2. The apparatus of example 1, further comprising a pump coupled to the intermediate input port and configured to direct the fluid into the separation channel.

Example 3. The apparatus of any of examples 1-2, wherein the intermediate position is situated between 30% and 70% of the separation channel length, optionally 40% to 60%, optionally 45% to 55%, optionally 48% to 52%.

Example 4. The apparatus of any of examples 1-3, wherein the at least one intermediate input port includes a valve operable to open allow fluid to flow through the separation channel during a cleaning procedure and to close to prevent flow through the at least one intermediate input port during a chromatography separation process along the separation channel.

Example 5. The apparatus of any of examples 1-4, wherein the intermediate position is configured to at least double a speed of cleaning and/or equilibrating the length of the separation channel.

Example 6. The apparatus of any of examples 1-5, further comprising a chromatography controller coupled to the chromatography column, the controller including a processor and memory configured with processor-executable instructions to, during a cleaning and/or equilibration procedure, cause fluid to be directed into the separation channel through at least the intermediate input port, and to, during a chromatography separation process, direct an analyte through the input port to travel along the length to perform a chromatography separation.

Example 7. The apparatus of any of examples 1-6, wherein the separation channel comprises a plurality of adjacent separation path segments connected to each other by connectors having a smaller cross-section than cross-sections of the separation path segments; wherein the plurality of separation path segments includes an input segment coupled to the column input port, an output segment coupled to the column output port, and a plurality of intermediate path segments.

Example 8. The apparatus of example 7, wherein at least one of the connectors coupling at least two of the intermediate path segments is coupled to the at least one intermediate input port.

Example 9. The apparatus of any of examples 7-8, further comprising at least one intermediate output port coupled to another intermediate position along the length of the separation channel, wherein the at least one intermediate output port is situated to receive fluid directed into the separation channel from the at least intermediate input port.

Example 10. The apparatus of example 9, wherein the at least one intermediate input port comprises a plurality of intermediate input ports situated to receive and direct the fluid into the separation channel, wherein the at least one intermediate output port comprises a plurality of intermediate output ports situated to receive and direct the fluid out of the separation channel that is directed into the separation channel through the at least one intermediate input port.

Example 11. The apparatus of example 10, wherein each intermediate input port is arranged on a first side of the plurality of intermediate path segments and each intermediate output port is arranged on an opposing side of the plurality of intermediate path segments to form an alternating arrangement of input ports and output ports along the length of the separation channel.

Example 12. The apparatus of any of examples 1-6, wherein the separation channel comprises a tube having a common cross-section and extending from the column input port to the column output port.

Example 13. The apparatus of example 12, further comprising at least one intermediate output port coupled to another intermediate position along the length of the separation channel, wherein the at least one intermediate output port is situated to receive fluid directed into the separation channel from the at least intermediate input port.

Example 14. The apparatus of example 13, wherein the at least one intermediate input port comprises a plurality of intermediate input ports situated to receive and direct the fluid into the separation channel, wherein the at least one intermediate output port comprises a plurality of intermediate output ports situated to receive and direct the fluid out of the separation channel that is directed into the separation channel through the at least one intermediate input port, wherein the intermediate input ports and intermediate outputs are alternately arranged along the length of the separation channel.

Example 15. The apparatus of example 12, wherein the tube includes a tube length portion at the intermediate position comprising the at least one intermediate input port, wherein the at least one intermediate input port comprises a first plurality of closely arranged holes or porous structures in a wall of the tube length portion, wherein the tube length portion includes a second plurality of closely arranged holes or porous structures in the wall and opposite the first plurality, wherein tube length portion includes at least one intermediate output port comprising the second plurality.

Example 16. The apparatus of example 15, further comprising a cover configured to removably cover the first and second pluralities of closely arranged holes or porous structures, wherein the cover is configured in a closed position to allow for separation along the separation channel and configured in an open position to allow flow perpendicular to the flow along the separation channel to clean and/or equilibrate the separation channel.

Example 17. A method, comprising: in a chromatography column including a separation channel having a length extending between a column input port and a column output port and at least one intermediate input port coupled to an intermediate position along the length of the separation channel, directing a fluid into the separation channel through the at least one intermediate input port to travel toward the column input port and toward the column output port to clean the separation channel.

Example 18. The method of example 17, wherein the separation channel comprises a plurality of adjacent separation path segments connected to each other by connectors having a smaller cross-section than cross-sections of the separation path segments, wherein the plurality of separation path segments includes an input segment coupled to the column input port, an output segment coupled to the column output port, and a plurality of intermediate path segments, wherein at least one of the connectors coupling at least two of the intermediate path segments is coupled to the at least one intermediate input port, wherein the separation channel comprises at least one intermediate output port coupled to another intermediate position along the length of the separation channel; wherein the method further comprises directing at least a portion of the fluid out the at least one intermediate output port.

Example 19. The method of example 17, wherein the separation channel comprises a tube having a common cross-section and extending from the column input port to the column output port, wherein the column includes at least one intermediate output port coupled to another intermediate position along the length of the separation channel; wherein the method further comprises directing at least a portion of the fluid out the at least one intermediate output port.

Example 20. The method of example 17, wherein the separation channel comprises a tube having a common cross-section and extending from the column input port to the column output port, wherein the tube includes a tube length portion at the intermediate position comprising the at least one intermediate input port, wherein the at least one intermediate input port comprises a first plurality of closely arranged holes or porous structures in a wall of the tube length portion, wherein the tube length portion includes a second plurality of closely arranged holes or porous structures in the wall and opposite the first plurality, wherein tube length portion includes at least one intermediate output port comprising the second plurality; wherein the method further comprises, without blocking the first and second pluralities, directing the fluid perpendicular to the flow along the separation channel from the plurality to the second plurality to clean and/or equilibrate the separation channel.

Example 21. An apparatus comprising a chromatography column of any of examples 1-20, wherein the column is a capillary-type column.

Example 22. An apparatus comprising a chromatography column of any of examples 2-10, wherein the column is a substrate-type column.

Example 23. A computer readable medium comprising instructions for carrying out any of the chromatography column operation steps for any of the examples 1-22.

Example 24. An apparatus comprising a processor and memory configured with processor-executable instructions for carrying out any of the chromatography operation steps for any of examples 1-22.

Example 25. An apparatus comprising a capillary-type chromatography column including a capillary tube separation channel having a length extending between a column input port and a column output port and at least one intermediate input port coupled to an intermediate position along the length of the separation channel, wherein the at least one intermediate input port is situated to receive and direct a fluid into the separation channel, wherein the separation channel comprises a tube having a common cross-section and extending from the column input port to the column output port.

Example 26. The apparatus of example 25, further comprising the features or steps of any of examples 1-24.

In view of the many possible examples in which the principles of the disclosed technology may be applied, it should be recognized that the illustrated examples are only preferred examples and should not be taken as limiting the scope of the disclosed technology. Rather, the scope is defined by the following claims. We therefore claim all that comes within the scope of these claims.

We claim:

1. An apparatus comprising:
a chromatography column including a separation channel having a length extending between a column input port and a column output port and at least one intermediate input port coupled to an intermediate position along the length of the separation channel, wherein the at least one intermediate input port is situated to receive and direct a fluid into the separation channel to travel toward the column input port and toward the column output port and to clean the separation channel.

2. The apparatus of claim 1, further comprising a pump coupled to the intermediate input port and configured to direct the fluid into the separation channel.

3. The apparatus of claim 1, wherein the intermediate position is situated between 30% and 70% of the separation channel length.

4. The apparatus of claim 1, wherein the at least one intermediate input port includes a valve operable to open allow fluid to flow through the separation channel during a cleaning procedure and to close to prevent flow through the at least one intermediate input port during a chromatography separation process along the separation channel.

5. The apparatus of claim 1, wherein the intermediate position is configured to at least double a speed of cleaning and/or equilibrating the length of the separation channel.

6. The apparatus of claim 1, further comprising a chromatography controller coupled to the chromatography column, the controller including a processor and memory configured with processor-executable instructions to, during a cleaning and/or equilibration procedure, cause fluid to be directed into the separation channel through at least the intermediate input port, and to, during a chromatography separation process, direct an analyte through the input port to travel along the length to perform a chromatography separation.

7. The apparatus of claim 1, wherein the separation channel comprises a plurality of adjacent separation path segments connected to each other by connectors having a smaller cross-section than cross-sections of the separation path segments;
wherein the plurality of separation path segments includes an input segment coupled to the column input port, an output segment coupled to the column output port, and a plurality of intermediate path segments.

8. The apparatus of claim 7, wherein at least one of the connectors coupling at least two of the intermediate path segments is coupled to the at least one intermediate input port.

9. The apparatus of claim 7, further comprising at least one intermediate output port coupled to another intermediate position along the length of the separation channel, wherein the at least one intermediate output port is situated to receive fluid directed into the separation channel from the at least intermediate input port.

10. The apparatus of claim 9, wherein the at least one intermediate input port comprises a plurality of intermediate input ports situated to receive and direct the fluid into the separation channel, wherein the at least one intermediate output port comprises a plurality of intermediate output ports situated to receive and direct the fluid out of the separation channel that is directed into the separation channel through the at least one intermediate input port.

11. The apparatus of claim 10, wherein each intermediate input port is arranged on a first side of the plurality of intermediate path segments and each intermediate output port is arranged on an opposing side of the plurality of intermediate path segments to form an alternating arrangement of input ports and output ports along the length of the separation channel.

12. The apparatus of claim 1, wherein the separation channel comprises a tube having a common cross-section and extending from the column input port to the column output port.

13. The apparatus of claim 12, further comprising at least one intermediate output port coupled to another intermediate position along the length of the separation channel, wherein the at least one intermediate output port is situated to receive fluid directed into the separation channel from the at least intermediate input port.

14. The apparatus of claim 13, wherein the at least one intermediate input port comprises a plurality of intermediate input ports situated to receive and direct the fluid into the separation channel, wherein the at least one intermediate output port comprises a plurality of intermediate output ports situated to receive and direct the fluid out of the separation channel that is directed into the separation channel through the at least one intermediate input port, wherein the intermediate input ports and intermediate outputs are alternately arranged along the length of the separation channel.

15. The apparatus of claim 12, wherein the tube includes a tube length portion at the intermediate position comprising the at least one intermediate input port, wherein the at least one intermediate input port comprises a first plurality of closely arranged holes or porous structures in a wall of the tube length portion, wherein the tube length portion includes a second plurality of closely arranged holes or porous structures in the wall and opposite the first plurality, wherein tube length portion includes at least one intermediate output port comprising the second plurality.

16. The apparatus of claim 15, further comprising a cover configured to removably cover the first and second pluralities of closely arranged holes or porous structures, wherein the cover is configured in a closed position to allow for separation along the separation channel and configured in an open position to allow flow perpendicular to the flow along the separation channel to clean and/or equilibrate the separation channel.

17. A method, comprising:
in a chromatography column including a separation channel having a length extending between a column input port and a column output port and at least one intermediate input port coupled to an intermediate position along the length of the separation channel, directing a fluid into the separation channel through the at least one intermediate input port to travel toward the column input port and toward the column output port to clean the separation channel.

18. The method of claim 17, wherein the separation channel comprises a plurality of adjacent separation path segments connected to each other by connectors having a smaller cross-section than cross-sections of the separation path segments, wherein the plurality of separation path segments includes an input segment coupled to the column input port, an output segment coupled to the column output port, and a plurality of intermediate path segments, wherein at least one of the connectors coupling at least two of the intermediate path segments is coupled to the at least one intermediate input port, wherein the separation channel comprises at least one intermediate output port coupled to another intermediate position along the length of the separation channel;
wherein the method further comprises directing at least a portion of the fluid out the at least one intermediate output port.

19. The method of claim 17, wherein the separation channel comprises a tube having a common cross-section and extending from the column input port to the column output port, wherein the column includes at least one intermediate output port coupled to another intermediate position along the length of the separation channel;
wherein the method further comprises directing at least a portion of the fluid out the at least one intermediate output port.

20. The method of claim 17, wherein the separation channel comprises a tube having a common cross-section and extending from the column input port to the column output port, wherein the tube includes a tube length portion at the intermediate position comprising the at least one intermediate input port, wherein the at least one intermediate input port comprises a first plurality of closely arranged holes or porous structures in a wall of the tube length portion, wherein the tube length portion includes a second plurality of closely arranged holes or porous structures in the wall and opposite the first plurality, wherein tube length portion includes at least one intermediate output port comprising the second plurality;
wherein the method further comprises, without blocking the first and second pluralities, directing the fluid perpendicular to the flow along the separation channel from the plurality to the second plurality to clean and/or equilibrate the separation channel.
